(19) United States
(12) Patent Application Publication
(10) Pub. No.: US 2017/0274411 A1
(43) Pub. Date: Sep. 28, 2017

(54) WIPER SYSTEM

(71) Applicant: WESTERN TUBE & CONDUIT CORPORATION, Long Beach, CA (US)

(72) Inventor: Kevin Carroll, Long Beach, CA (US)

(21) Appl. No.: 15/145,490

(22) Filed: May 3, 2016

Related U.S. Application Data
(60) Provisional application No. 62/311,637, filed on Mar. 22, 2016.

(51) Int. Cl. B05C 11/02

(52) U.S. Cl. CPC B05C 11/021

(57) ABSTRACT

A wiper system configured to apply and wipe one or more coatings on a rigid tube includes a tapered wiper tapering between a wider end defining an inlet orifice and a narrower end defining an exit orifice. The narrower end of the tapered wiper includes a series of slits arranged circumferentially around the exit orifice. The slits define a series of resilient tabs configured to deflect radially outward when contacted by one or more formations on an outer surface of the rigid tube and configured to return to a neutral position when the one or more formations have passed through the exit orifice. The wiper system may also include a gimbal supporting the tapered wiper. The gimbal is configured to permit the tapered wiper to rotate about first and second mutually perpendicular axes when the tapered wiper is contacted by a bowed rigid tube.

### CROSS-REFERENCE TO RELATED APPLICATION

This application claims priority to and the benefit of U.S. Provisional Application No. 62/311,637, filed Mar. 22, 2016, the entire contents of which are incorporated herein by reference.

### FIELD

The present disclosure relates generally to wiper systems for applying coatings to tubes.

### BACKGROUND

Steel tubes are used in a variety of applications, including sprinkler systems, fence posts, and rigid conduits. To prevent the steel tubes from rusting, the steel tubes are typically galvanized. One conventional galvanization process is hot-dip galvanizing in which the steel tubes are submerged into a molten zinc bath and then extracted in a piece-wise fashion. The steel tubes are then transported through a compressed air wiper ring that blows excess zinc off the outer surfaces of the steel tubes and a blast of super-heated steam is used to blow the excess molten zinc out from the insides of the tubes. The steel tubes are then submerged in a quench bath. During the process of transporting the steel tubes to the quench bath, rough frozen lumps of zinc may form on the surfaces of the steel tubes.

To prevent or mitigate the formation of unsightly white rust on the surface of the steel tubes, many conventional galvanizing processes apply a secondary coating to the steel tubes. In conventional operations, the secondary coatings are typically applied by dip tanks or spray nozzle assemblies. However, these secondary coatings often contain toxic chemicals, such as hexavalent chromium, and during the process of applying the secondary coating by dipping or spraying, the secondary coatings may drip, splash, and/or atomize, which can cause environmental problems and/or health problems.

Additionally, conventional wiper systems are unsuitable for applying secondary coatings to steel tubes because the steel tubes may include various defects, such as curvature (known in the art as “bananas”), burrs on the ends of the tubes, or rough zinc formations on the outer surfaces of the tubes, which would prematurely wear or damage conventional wiper systems.

### SUMMARY

The present disclosure is directed to various embodiments of a wiper system configured to wipe an excess of one or more coatings applied to a rigid tube. In one embodiment, the wiper system includes a tapered wiper tapering between a wider end defining an inlet orifice and a narrower end defining an exit orifice. The narrower end of the tapered wiper includes a series of slits arranged circumferentially around the exit orifice. The series of slits define a series of resilient tabs configured to deflect radially outward when contacted by one or more formations on an outer surface of the rigid tube and to return to a neutral position when the one or more formations have passed through the exit orifice. The tapered wiper may include from 12 to 36 slits. Each of the slits may have a length from approximately ¼ inch to approximately 1 inch. The resilient tabs may include a resilient material such as polyurethane, neoprene, or spring metal. The tapered wiper may include polyurethane having a hardness of 95 Shore A. The wiper system may include a gimbal movably supporting the tapered wiper. The gimbal may be a dual-axis gimbal configured to permit the tapered wiper to rotate about a first axis perpendicular to a longitudinal axis of the tapered wiper and to rotate about a second axis perpendicular to the longitudinal axis and orthogonal to the first axis when the tapered wiper is contacted by the rigid tube. The tapered wiper may be frusto-conical.

A wiper system configured to wipe an excess of one or more coatings applied to a rigid tube according to another embodiment of the present disclosure includes a gimbal and a tapered wiper movably supported on the gimbal. The tapered wiper tapers between a wider end defining an inlet orifice and a narrower end defining an exit orifice. The gimbal is configured to permit the tapered wiper to rotate freely about a first axis perpendicular to a longitudinal axis of the tapered wiper and to rotate freely about a second axis perpendicular to the longitudinal axis and orthogonal to the first axis when the tapered wiper is contacted by the rigid tube. The gimbal may include inner ring coupled to the tapered wiper by a first pair of opposing bearings defining the first axis and an outer ring coupled to the inner ring by a second pair of opposing bearings defining the second axis. The first axis may be co-planar with the second axis. The tapered wiper may be a two-piece assembly including a forward wiper section coupled to the gimbal and an aft wiper section detachably coupled to the forward wiper section. The gimbal may be coupled to the tapered wiper at a location proximate to the wider end defining the inlet orifice. A ratio of a size of the inlet orifice to a size of the exit orifice may be from approximately 7:4 to approximately 7:1. The inlet orifice may have a diameter of at least approximately 5 inches. The tapered wiper may taper at an angle from approximately 25 degrees to approximately 45 degrees with respect to a longitudinal axis of the tapered wiper.

The narrower end of the tapered wiper may include a series of slits arranged circumferentially around the exit orifice. The slits defining a series of resilient tabs configured to deflect radially outward when contacted by one or more formations on an outer surface of the rigid tube and to return to a neutral position when the one or more formations have passed through the exit orifice. The resilient tab may include a resilient material such as polyurethane, neoprene, or spring metal. The wiper system may also include a conveyor for transporting the rigid tube through the tapered wiper. The wiper system may include a coating delivery mechanism for delivering the one or more coatings.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

### BRIEF DESCRIPTION OF THE DRAWINGS

The features and/or advantages of embodiments of the present disclosure will become more apparent by reference to the following detailed description when considered in conjunction with the following drawings. In the drawings, like reference numerals are used throughout the figures to reference like features and components. The figures are not necessarily drawn to scale, nor is every feature in the drawings necessarily required to fall within the scope of the described invention.

FIGS. 1A-1D are a top view, a side view, a first front view, and a second front view, respectively, of a wiper system including a conveyor, a tapered wiper, a gimbal, and a coating delivery mechanism according to one embodiment of the present disclosure; and

FIGS. 2A-2B are a front perspective view and a rear perspective view, respectively, of the tapered wiper and the gimbal of the embodiment of the wiper system illustrated in FIGS. 1A-1D.

### DETAILED DESCRIPTION

The present disclosure is directed to various embodiments of a wiper system configured to apply one or more coatings, such as a passivation coating (e.g., hexavalent chromium), to tubes (e.g., steel tubes), and to wipe an excess of the one or more coatings off of the tubes, during a process of galvanizing the tubes. The wiper system of the present disclosure may be used to apply any suitable type of coating, such as, for instance, dilute and reactive waterborne coatings or molten coatings. The wiper system according to various embodiments of the present disclosure is configured to apply and wipe one or more coatings on tubes with defects, such as non-linearity (e.g., curved tubes known in the art as “bananas”), burrs on the ends of the tubes, and/or deposit formations (e.g., rough frozen zinc formations) on the outer surfaces of the tubes. Additionally, the wiper system of the present disclosure is configured to reduce splashing, spilling, and atomization of the coating solution, which could cause environmental and health problems, compared to conventional dipping or spraying processes.

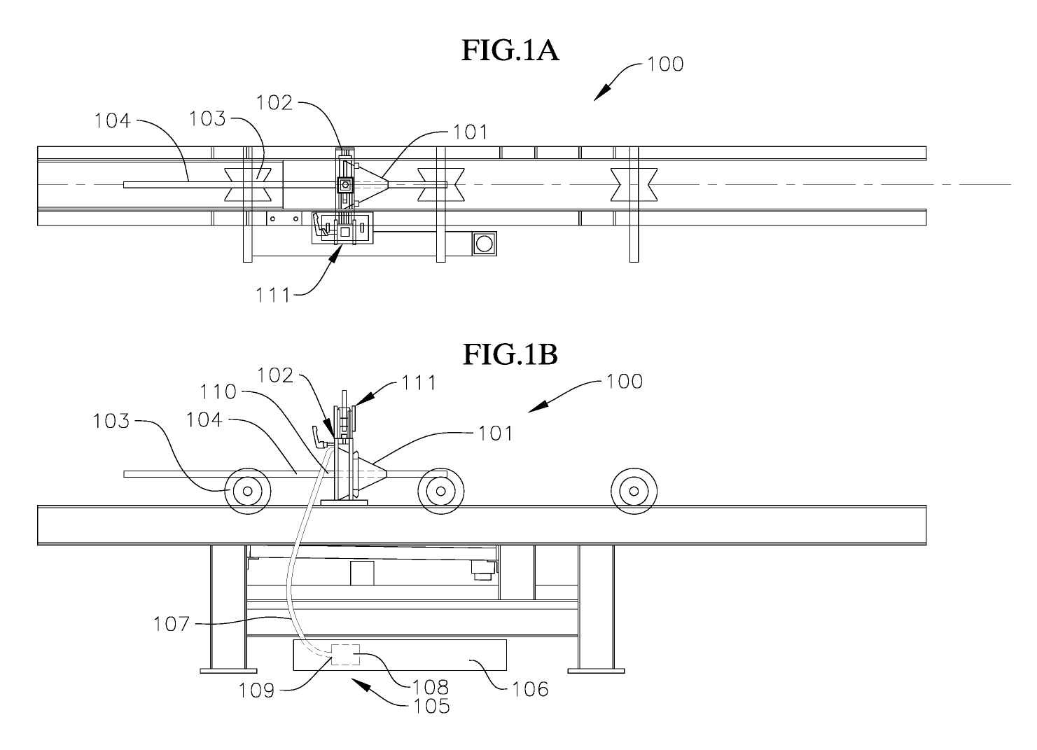

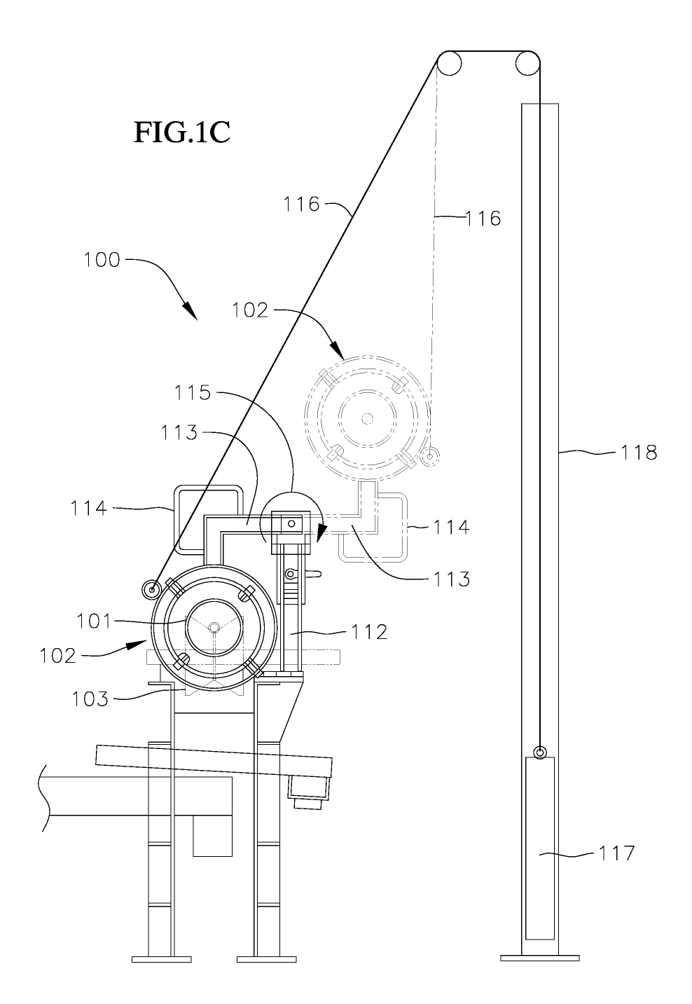

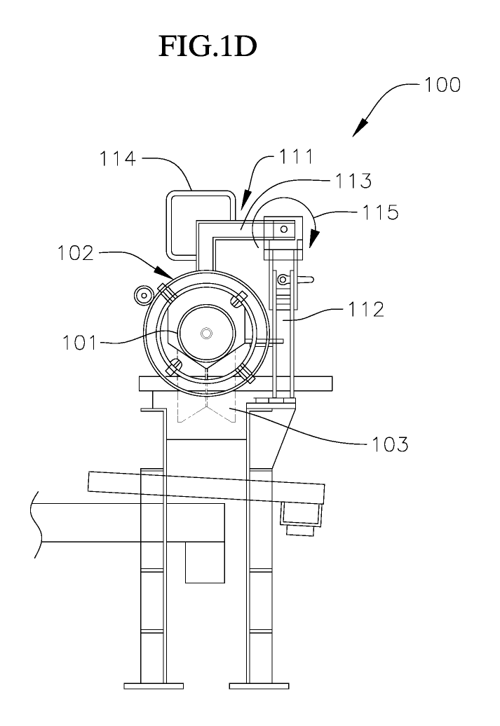

With reference now to FIGS. 1A-1D, a wiper system 100 according to one embodiment of the present disclosure includes a hollow tapered wiper 101 movably supported on a gimbal 102, a conveyor system 103 (e.g., a linear conveyor including a series of rollers) for transporting a continuous length of tubing or a series of discrete tube segments 104 through the tapered wiper 101, and a coating delivery mechanism 105 for delivering a coating solution (e.g., a passivation coating such as hexavalent chromium) onto the one or more tubes 104 before they pass through the tapered wiper 101. The wiper system 100 of the present disclosure is a “flood and wipe” type system in which the coating delivery mechanism 105 pours the coating solution onto the tubes 104 and then the tapered wiper 101 wipes an excess of the coating solution off of the tubes 104 as the tubes 104 pass through the tapered wiper 101.

In one embodiment,the coating delivery mechanism 105 includes a reservoir 106 containing a volume of a coating solution (e.g., a passivation coating such as hexavalent chromium), a fluid conduit (e.g., a tube) 107, and a pump 108. An inlet end 109 of the conduit 107 is located in the reservoir 106 and an outlet end 110 of the conduit 107 is coupled to the tapered wiper 101. The pump 108 is configured to transport the coating solution from the reservoir 106, into the inlet end 109 of the conduit 107, out through the outlet end 110 of the conduit 107, and onto the tubes 104 passing through the tapered wiper 101.

In the illustrated embodiment, the wiper system 100 also includes a mechanism 111 for moving the tapered wiper 101 and the gimbal 102 between an operational position and a non-operational position. FIG. 1C illustrates the wiper system 100 in both the operational and non-operational positions and FIG. 1D illustrates the wiper system 100 in the operational position. In the operational position, the tapered wiper 101 is in-line or substantially in-line with the conveyor system 103 and the wiper system 100 is configured for use in a tube coating operation. When the wiper system 100 is not in use to coat tubes (e.g., during maintenance), the tapered wiper 101 may be moved into the non-operational position in which the tapered wiper 101 is misaligned with the conveyor system 103. In the illustrated embodiment, the mechanism 111 includes a support member (e.g., a stanchion) 112 coupled to the conveyor system 103, a swing arm (e.g., an elbow) 113 having a first end coupled to the gimbal 102 and a second end hingedly coupled to the support member 112, and a handle 114 coupled to the swing arm 113. To move the gimbal 102 and the tapered wiper 101 between the operational and non-operational positions, as illustrated in FIG. 1C, an operator may grasp the handle 114 and rotate (arrow 115) the swing arm 113, the gimbal 102, and the tapered wiper 101 about the support member 112.

Additionally, in the illustrated embodiment, the mechanism 111 also includes a tensile member (e.g., a cable) 116 have a first end coupled to the gimbal 102 and a second end coupled to a counter weight 117 slidably retained in a counter weight shaft 118. The counter weight 117, which is coupled to the gimbal 102 by the tensile member 116, is configured to assist the operator in moving (arrow 115) the gimbal 102 and the tapered wiper 101 between the operational and non-operational positions. In one or more embodiments, the wiper system 100 may include any other suitable mechanism for moving the gimbal 102 and the tapered wiper 101 between the operational and non-operational positions, such as, for instance, a motor.

In one or more embodiments, the wiper system 100 may also include a heating mechanism for heating the one or more tubes 104 and/or the coating solution (e.g., the passivation coating). The heating mechanism may be positioned to heat the one or more tubes 104 before entering the tapered wiper 101 and/or after passing through the tapered wiper 101. The heating mechanism may be configured to heat the one or more tubes 104 before the coating has been applied to the one or more tubes 104 or after the coating has been applied to the one or more tubes 104. The heating mechanism may be any suitable type or kind of heating mechanism, such as an induction coil, an oven, a radiation-emission device (e.g., a device emitting ultraviolet light or electron beams), a hot-air blower, or combinations thereof.

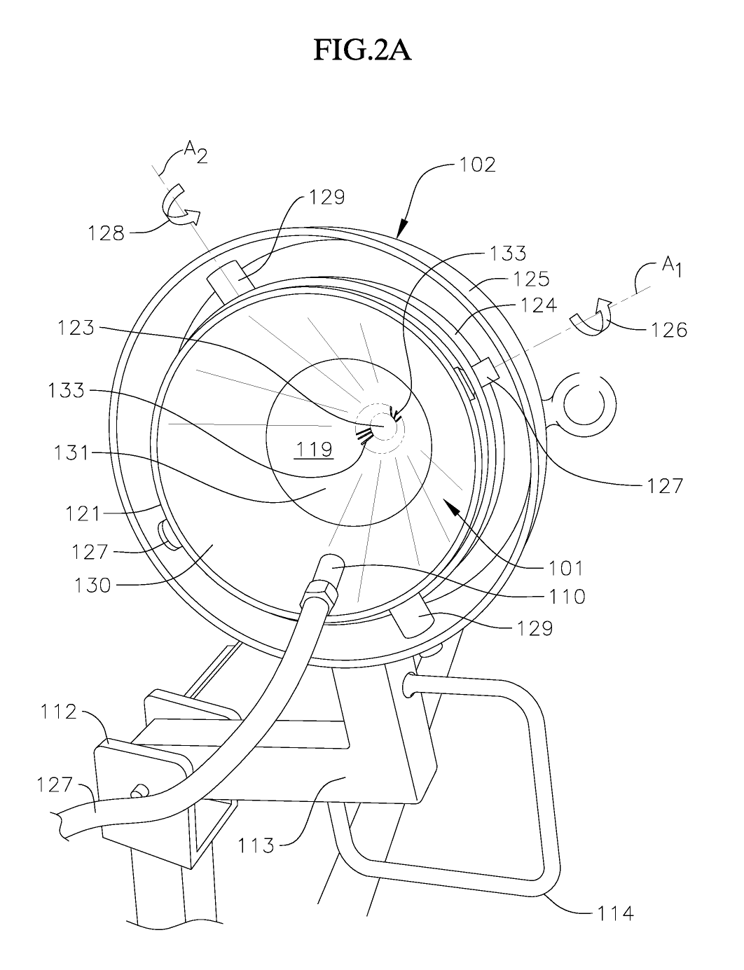

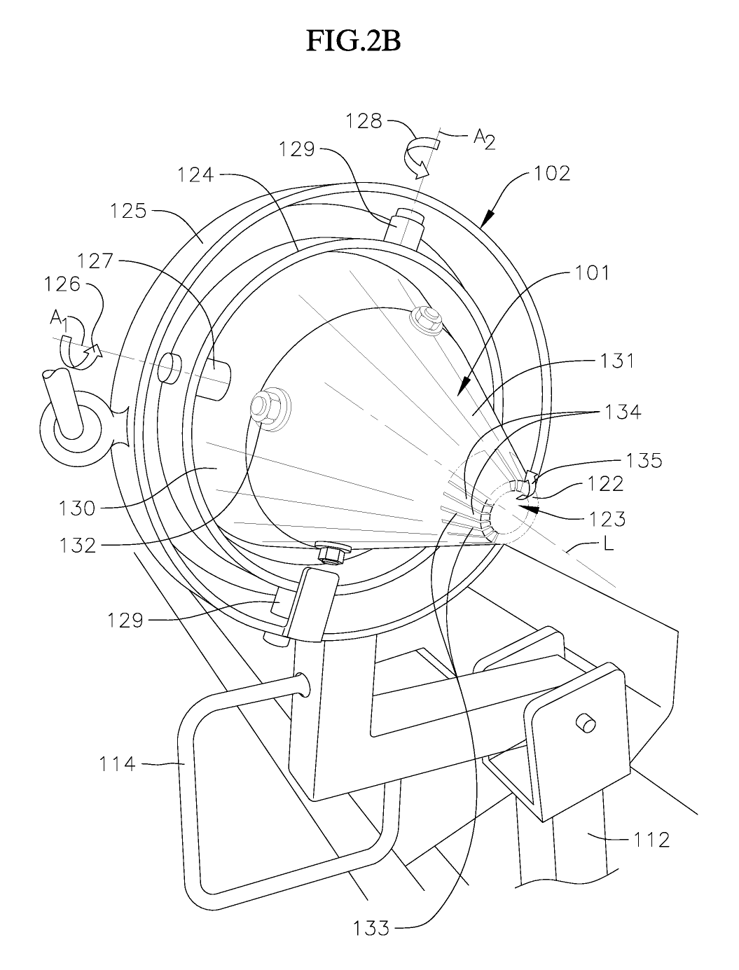

With reference now to FIGS. 2A-2B, the tapered wiper 101 includes at least one sidewall 119 tapering between a wider inlet end 120 defining an inlet orifice 121 and a narrower outlet end 122 defining an exit orifice 123. The tapered wiper 101 may have any suitable tapered shape, such as, for instance, a frusto-conical shape. As described in more detail below, the conveyor system 103 is configured to transport the continuous length of tube or the series of discrete tubes 104 in through the inlet orifice 121 of the tapered wiper 101 and out through the exit orifice 123 of the tapered wiper 101.

The tapered wiper 101 may have any size suitable for the cross-sectional size (e.g., diameter) of the tube or tube segments 104 the wiper system 100 is intended to coat. In one embodiment, the inlet orifice 121 of the tapered wiper 101 has a diameter of approximately 10 inches. In one or more embodiments, the inlet orifice 121 may have a diameter from approximately 12 inches to approximately 4 inches, such as, for instance, approximately 7 inches. In one or more embodiments, the inlet orifice 121 may have any other suitable size depending, for instance, on the size (e.g., diameter) of the one or more tubes 104 the wiper system 100 is intended to coat and/or the extent to which the one or more tubes 104 are bowed, as described in more detail below. In one embodiment, the exit orifice 123 may have a size (e.g., an inner diameter) equal or substantially equal to a size (e.g., an outer diameter) of the one or more tube 104 that the wiper system 100 is intended to coat. In one or more embodiments, the exit orifice 123 may have a size (e.g., an inner diameter) slightly smaller than the size (e.g., the outer diameter) of the one or more tubes 104. In one or more embodiments, a ratio of the size (e.g., diameter) of the inlet orifice 121 to a size (e.g., diameter) of the exit orifice 123 may be from approximately 3:2 to approximately 10:1, such as, for instance, from approximately 7:4 to approximately 7:1. Additionally, the tapered wiper 101 may have any suitable length along a longitudinal axis L of the tapered wiper 101 from the wider inlet end 120 to the narrower outlet end 122, such as, for instance, from approximately 12 inches to approximately 4 inches (e.g., approximately 10 inches). Additionally, in one or more embodiments, the sidewall 119 of the tapered wiper 101 may taper at any suitable angle α with respect to a longitudinal axis L of the tapered wiper 101, such as, for instance, at an angle α from approximately 25 degrees to approximately 45 degrees.

The tapered wiper 101 may be made out of any suitably hard and elastic material configured to withstand repeated impacts from the one or more tubes 104 passing through the tapered wiper 101 such as, for instance, polyurethane, neoprene, spring metal (e.g., spring steel), or combinations thereof. The tapered wiper 101 may have any suitable hardness such as, for instance, 95 Shore A, 65 Shore A, or 40 Shore A on the durometer hardness scale. Additionally, the one or more sidewalls 119 of the tapered wiper 101 may have any suitable thickness, such as, for instance, from approximately ⅛ inch to approximately ½ inch (e.g., approximately 3/16 inch). The thickness of the sidewall 119 may vary depending, for instance, on the size of the tubes 104 the wiper system 100 is intended to coat, the size of the tapered wiper 101, the material of the tapered wiper 101, and/or the hardness of the material of the tapered wiper 101.

With continued reference to the embodiment illustrated in FIGS. 2A-2B the tapered wiper 101 is movably supported on the gimbal 102. In the illustrated embodiment, the gimbal 102 is a dual-axis gimbal including an inner ring 124 and an outer ring 125. The tapered wiper 101 is rotatably coupled (arrow 126) to the inner ring 124 about a first axis (e.g., a pitch axis) A₁ defined by a first pair of opposing pins (e.g., bearings) 127 connecting the tapered wiper 101 to the inner ring 124 of the gimbal 102. The tapered wiper 101 and the inner ring 124 are rotatably coupled (arrow 128) to the outer ring 125 about a second axis (e.g., a swivel axis) A₂ defined by a second pair of opposing pins (e.g., bearings) 129 connecting the inner ring 124 to the outer ring 125 of the gimbal 102. In the illustrated embodiment, the first and second axes A₁, A₂ are perpendicular or substantially perpendicular to the longitudinal axis L of the tapered wiper 101. Additionally, in the illustrated embodiment, the pair of pins 127 connecting the tapered wiper 101 to the inner ring 124 of the gimbal 102 is angularly offset by 90 degrees from the pair of pins 129 connecting the inner ring 124 to the outer ring 125 of the gimbal 102 such that the first axis A₁ is orthogonal or substantially orthogonal to the second axis A₂. Further, in the illustrated embodiment, the first pair of opposing pins 127 is co-planar or substantially co-planar with the second pair of opposing pins 129 such that the first axis A₁ of rotation is co-planar or substantially co-planar with the second axis A₂ of rotation. As described in more detail below, the tapered wiper 101 is configured to rotate (e.g., pitch) (arrow 126) about the first axis A₁ and/or rotate (e.g., swivel) (arrow 128) about the second axis A₂ of the gimbal 102 when a non-linear tube 104 (e.g., a curved tube known in the art as a “banana”) passes through the tapered wiper 101.

In the illustrated embodiment, the tapered wiper 101 is a two-piece assembly including a forward wiper section 130 and an aft wiper section 131 detachably coupled to the forward wiper section 130. The aft wiper section 131 may be detachably coupled to the forward wiper section 130 by any suitable mechanism, such as, for instance, mechanical fasteners. In the illustrated embodiment, a forward portion of the aft wiper section 131 overlaps an aft portion of the forward wiper section 130 in a lap joint configuration and the forward portion of the aft wiper section 131 and the aft portion of the forward wiper section 130 include corresponding openings (e.g., holes) receiving fasteners 132 detachably coupling the aft wiper section 131 to the forward wiper section 130. In one or more embodiments, the aft wiper section 131 may abut the forward wiper section 130 of the tapered wiper 101 in a butt joint configuration. The two-piece construction of the tapered wiper 101 is configured to facilitate rapid removal and replacement of the aft wiper section 131 due to, for instance, wear or failure of the aft wiper section 131 (e.g., due to repeated tube strikes) or a desire to reconfigure the wiper system 100 for a different size tube 104. For instance, the aft wiper section 131 may be removed and replaced with an aft wiper section 131 defining a larger or smaller exit orifice 123 to accommodate different size tubes 104. The two-piece construction of the tapered wiper 101 permits removal of the aft wiper section 131 without detachment of the forward wiper section 130 from the gimbal 102. Additionally, in one or more embodiments, the forward wiper section 130 and the aft wiper section 131 may include different materials. For instance, in one embodiment, the forward wiper section 130 may be formed of the same material as the gimbal 102 (e.g., steel) and the aft wiper section 131 may be formed of a more flexible material (e.g., polyurethane, neoprene, or spring metal). In one or more embodiments, the forward and aft tapered sections 130, 131 may be integral (e.g., the tapered wiper 101 may be a monolithic member).

In the illustrated embodiment, the at least one sidewall 119 of the tapered wiper 101 also defines a plurality of slits 133. The slits 133 are circumferentially arranged around the exit orifice 123. Each of the slits 133 extends from the narrower outlet end 122 of the tapered wiper 101 forward toward the wider inlet end 120 of the tapered wiper 101. The slits 133 define a plurality of resilient fingers or resilient tabs 134. Each resilient tab 134 is defined between an adjacent pair of slits 133. Each resilient tab 134 is configured to move between a neutral position and a deformed or deflected position in which the resilient tab 134 is flexed radially outward (e.g., curved or bent away from the longitudinal axis L of the tapered wiper 101). When a force is applied to the resilient tabs 134, the resilient tabs 134 are configured to move or flex (arrow 135) radially outward away from the longitudinal axis L of the tapered wiper 101 into the deformed position (i.e., the resilient tabs 134 are configured to splay). When the force is removed, the resilient tabs 134 are configured to return to the neutral position. The elastic material properties of the resilient tabs 134 (e.g., polyurethane, neoprene, and/or spring metal) are configured to bias the resilient tabs 134 into the neutral position. In general, the ease with which the resilient tabs 134 are deflected outward (arrow 135) is a function of the elasticity of the material of the resilient tabs 134, the thickness of the sidewall 119 of the tapered wiper 101, and the number and configuration of the slits 133 (e.g., the length of the slits 133). As described in more detail below, the slits 133 and the resilient tabs 134 of the tapered wiper 101 are configured to accommodate a tube 104 having one or more defects (e.g., burrs and/or deposit formations) passing through the tapered wiper 101.

In one embodiment, the slits 133 may cause narrow streaks along the tube 104 coated by the wiper system 100. In general, the greater number of slits 133 in the tapered wiper 101, the narrower the streaks that are formed on the tube 104. Accordingly, in one embodiment, the tapered wiper 101 may have a large number of slits 133, such as, for instance, from 12 to 36 slits (e.g., 24 slits), to minimize the width of the streaks on the tube 104. Additionally, in one or more embodiments, the slits 133 may have a minimal width to minimize the width of the streaks along the tube 104. In one embodiment, when the tabs 134 are in the neutral position (i.e., a non-deformed or unflexed position), the slits 133 have a negligible width such that adjacent tabs 134 engage or contact each other. When the resilient tabs 134 are moved into the deformed position, the resilient tabs 134 splay such that adjacent resilient tabs 134 are spaced apart by a gap (i.e., the width of the slits 133 increases as the resilient tabs 134 are flexed outward).

The configuration of the slits 133 (e.g., the length and spacing between the slits 133) and the number of slits 133 may vary depending on the size (e.g., diameter) of the exit orifice 123, the size (e.g., diameter) of the tube 104 that the wiper system 100 is intended to coat, and/or the material of the tapered wiper 101. Additionally, in one or more embodiments, the slits 133 may have a length from approximately ¼ inch to approximately 1 inch (e.g., approximately ⅜ inch). Suitable lengths for the slits 133 may increase with increasing size (e.g., increasing diameter) of the tubes 104 that the wiper system 100 is intended to coat.

In operation, the conveyor system 103 directs one or more tubes 104 toward the tapered wiper 101. When a non-linear tube (e.g., a curved or bowed tube) 104 is directed toward the tapered wiper 101 by the conveyor system 103, the tube 104 enters the inlet orifice 121 and strikes the sidewall 119 of the tapered wiper 101 before reaching the exit orifice 123. The contact between the tube 104 and the tapered wiper 101 causes the tapered wiper 101 to rotate (arrow 126 and/or arrow 128) about one or more of the axes A₁, A₂ of the gimbal 102 depending on the direction in which the tube 104 is curved. For instance, if the tube 104 is curved upward, the tube 104 will strike the sidewall 119 of the tapered wiper 101 and cause the tapered wiper 101 to rotate (e.g., pitch upward) (arrow 126) about the first axis A₁ of the gimbal 102. If the tube 104 is curved to the left or to the right, the tube 104 will strike the sidewall 119 of the tapered wiper 101 and cause the tapered wiper 101 to rotate (e.g., swivel left or right) (arrow 128) about the second axis A₂ of the gimbal 102. The tube 104 may be curved in such a manner that the tapered wiper 101 rotates (arrows 126, 128) about both the first and second axes A₁, A₂ of the gimbal 102. In this manner, the gimbal 102 is configured to permit the tapered wiper 101 to reorient such that the longitudinal axis L of the exit orifice 123 of the tapered wiper 101 is parallel or substantially parallel with an axis of the portion of the tube 104 passing through the exit orifice 123. Additionally, in one or more embodiments, the gimbal 102 is coupled to the tapered wiper 101 at a location along the sidewall 119 proximate to the wider inlet end 120 such that the curved tube 104 is configured to strike the sidewall 119 of the tapered wiper 101 aft of the gimbal 102 (i.e., the tapered wiper 101 is configured such that the tube 104 strikes a portion of the sidewall 119 between the narrower outlet end 122 of the tapered wiper 101 and the gimbal 102). When the tube 104 strikes the sidewall 119 of the tapered wiper 101 aft of the gimbal 102, the tapered wiper 101 is configured to rotate (arrows 126, 128) (e.g., pitch up or down and/or swivel left or right) in the direction of the curvature of the tube 104. Otherwise, if the curved tube 104 struck the tapered wiper 101 at a position along the sidewall 119 forward of the gimbal 102, the tapered wiper 101 would not rotate in the direction of the curvature of the curved tube 104.

In one embodiment, the tapered wiper 101 is made of a sufficiently hard and/or resilient material (e.g., polyurethane having a hardness of 95 Shore A) to permit the force created by the contact between the tube 104 and the tapered wiper 101 to be transmitted to the gimbal 102, thereby reorienting the tapered wiper 101. Otherwise, if the material of the tapered wiper 101 were too soft, the contact between the tube 104 and the tapered wiper 101 could excessively deform the tapered wiper 101 and thereby transmit insufficient force to cause the tapered wiper 101 to rotate (arrows 126, 128) about the gimbal 102. Additionally, in one or more embodiments, the inlet orifice 121 of the tapered wiper 101 has a sufficient size (e.g., a diameter of approximately 5 inches or more, such as, for instance, approximately 7 inches) to capture bowed tubes 104 and the tapered wiper 101 tapers at a suitable angle (e.g., from approximately 25 degrees to approximately 45 degrees) with respect to a longitudinal axis of the tapered wiper 101 to permit the tapered wiper 101 to rotate (e.g., pitch up or down and/or swivel left or right) on the gimbal 102 when the tapered wiper 101 is struck by the bowed tube 104. Otherwise, if the inlet orifice 121 of the tapered wiper 101 were insufficiently sized, the bowed tubes 104 may not enter the tapered wiper 101 (e.g., excessively bowed tubes 104 may pass by the tapered wiper 101 and thus not get properly coated) and if the taper angle of the tapered wiper 101 were too severe, the bowed tube 104 may strike the sidewall 119 of the tapered wiper 101 and rebound off of the sidewall 119 (i.e., the bowed tube 104 could bounce off of the sidewall 119 and thus not pass through the exit orifice 123 of the tapered wiper 101), either of which would cause downtime in the coating process. For instance, in one or more embodiments in which the inlet orifice 121 of the tapered wiper 101 has a diameter of approximately 7 inches, the tapered wiper 101 is configured to accommodate an approximately 1 inch diameter tube 104 having a bow of approximately 3 inches or an approximately 4 inch diameter tube 104 having a bow of approximately 1.5 inches. In general, smaller tubes 104 are susceptible to being bowed to a greater extent than larger tubes 104. Bow is defined as the maximum deviation from the ideal center line between opposite ends of the tube 104.

As the conveyor system 103 continues to advance the tube 104, a portion of the tube 104 passes through the exit orifice 123 of the tapered wiper 101. When a tube 104 having one or more defects, such as burrs and/or deposit formations (e.g., rough frozen zinc formations) projecting from an outer surface of the tube 104, passes through the exit orifice 123 of the tapered wiper 101, the resilient tabs 134 that are contacted by the defect flex outward (arrow 135) into the deformed position to permit the defects to freely pass through the exit orifice 123 of the tapered wiper 101 (i.e., the resilient tabs 134 flex outward away from the longitudinal axis L of the tapered wiper 101 and thereby increase the effective size of the exit orifice 123 of the tapered wiper 101 to permit the tube 104 having the one or more defects to pass through the exit orifice 123). Otherwise, the contact between the one or more defects on the tube 104 (e.g., the burrs and/or the deposit formations) and the narrower outlet end 122 of the tapered wiper 101 could plug the tapered wiper 101 and/or could prematurely degrade or damage the tapered wiper 101 (e.g., the defects on the tube 104 could rip, tear, and/or cut the tapered wiper 101), which would cause downtime in the coating process. Additionally, in one or more embodiments, the resilient tabs 134 may be flexed outward (arrow 135) due to hydraulic lift caused by the coating on the tube 104.

As the conveyor system 103 transports the one or more tubes 104 toward the tapered wiper 101, the coating delivery mechanism 105 delivers the coating solution (e.g., a passivation coating such as hexavalent chromium) onto the tubes 104 before the tubes 104 pass through the exit orifice 123 of the tapered wiper 101. For instance, in one embodiment, the pump 108 is configured to transport the coating fluid from the reservoir 106, into the inlet end 109 of the conduit 107, and out through the outlet end 110 of the conduit 107. In one embodiment, the outlet end 110 of the conduit 107 is positioned on an upper end of the tapered wiper 101 such that the coating fluid pours out of the outlet end 110 of the conduit 107 down onto the tube 104 passing through the tapered wiper 101. As the tube 104 passes through the exit orifice 123 of the tapered wiper 101, the resilient tabs 134 are configured wipe an excess of the coating solution off of the outer surface of tube 104.

In the manner described above, the gimbal 102 and the resilient tabs 134 defined by the slits 133 at the narrower outlet end 122 of the tapered wiper 101 are configured to permit the wiper system 100 of the present disclosure to apply and wipe one or more coatings (e.g., a passivation coating such as hexavalent chromium) on one or more tubes 104 with defects, such as, non-linearity (e.g., curved tubes), burrs, and/or deposit formations (e.g., rough frozen zinc formations) on the outer surfaces of the tubes 104. Additionally, the wiper system 100 of the present disclosure is configured to reduce splashing and spilling of the coating solution, which could cause environmental and health problems, compared to conventional dipping or spraying processes that are typically used to coat tubes having one or more defects.

While this invention has been described in detail with particular references to embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention. One or more of the features described with reference to one embodiment may be combined with one or more other features described with reference to one or more other embodiments to provide a workable device. Although relative terms such as “forward,” backward,” “outer,” “inner,” “upper,” “lower,” and similar terms have been used herein to describe a spatial relationship of one element to another, it is understood that these terms are intended to encompass different orientations of the various elements and components of the invention in addition to the orientation depicted in the figures. Additionally, as used herein, the term “substantially” and similar terms are used as terms of approximation and not as terms of degree, and are intended to account for the inherent deviations in measured or calculated values that would be recognized by those of ordinary skill in the art. Furthermore, as used herein, when a component is referred to as being “on” or “coupled to” another component, it can be directly on or attached to the other component or intervening components may be present therebetween. Further, any described feature is optional and may be used in combination with one or more other features to achieve one or more benefits.

1. A wiper system configured to wipe one or more coatings on a rigid tube, comprising:
a tapered wiper tapering between a wider end defining an inlet orifice and a narrower end defining an exit orifice,
wherein the narrower end of the tapered wiper comprises a plurality of slits arranged circumferentially around the exit orifice, the plurality of slits defining a plurality of resilient tabs configured to deflect radially outward when contacted by one or more formations on an outer surface of the rigid tube and configured to return to a neutral position when the one or more formations have passed through the exit orifice, and
a gimbal movably supporting the tapered wiper,
wherein the gimbal is a dual-axis gimbal configured to permit the tapered wiper to rotate about a first axis perpendicular to a longitudinal axis of the tapered wiper and to rotate about a second axis perpendicular to the longitudinal axis and orthogonal to the first axis when the tapered wiper is contacted by the rigid tube.

2. The wiper system of claim 1, wherein the tapered wiper comprises from 12 to 36 slits.

3. The wiper system of claim 1, wherein each slit of the plurality of slits has a length from approximately ¼ inch to approximately 1 inch.

4. The wiper system of claim 1, wherein the plurality of resilient tabs comprises a resilient material selected from the group of materials consisting of polyurethane, neoprene, and spring metal.

5. The wiper system of claim 1, wherein the tapered wiper comprises polyurethane having a hardness of 95 Shore A.

6-7. (canceled)

8. The wiper system of claim 1, wherein the tapered wiper is frusto-conical.

9. A wiper system configured to wipe one or more coatings on a rigid tube, comprising:
a gimbal; and
a tapered wiper movably supported on the gimbal, the tapered wiper tapering between a wider end defining an inlet orifice and a narrower end defining an exit orifice,
wherein the gimbal is configured to permit the tapered wiper to rotate freely about a first axis perpendicular to a longitudinal axis of the tapered wiper and to rotate freely about a second axis perpendicular to the longitudinal axis and orthogonal to the first axis when the tapered wiper is contacted by the rigid tube.

10. The wiper system of claim 9, wherein the gimbal comprises:
an inner ring coupled to the tapered wiper by a first pair of opposing bearings defining the first axis; and
an outer ring coupled to the inner ring by a second pair of opposing bearings defining the second axis.

11. The wiper system of claim 9, wherein the first axis is co-planar with the second axis.

12. The wiper system of claim 9, wherein the tapered wiper is a two-piece assembly comprising a forward wiper section and an aft wiper section detachably coupled to the forward wiper section, and wherein the forward wiper section is coupled to the gimbal.

13. The system of claim 9, wherein the gimbal is coupled to the tapered wiper at a location proximate to the wider end of the tapered wiper defining the inlet orifice.

14. The wiper system of claim 9, wherein a ratio of a size of the inlet orifice to a size of the exit orifice is from approximately 7:4 to approximately 7:1.

15. The wiper system of claim 9, wherein the inlet orifice has a diameter of at least approximately 5 inches.

16. The wiper system of claim 9, wherein the tapered wiper tapers at an angle from approximately 25 degrees to approximately 45 degrees with respect to a longitudinal axis of the tapered wiper.

17. The wiper system of claim 9, wherein the narrower end of the tapered wiper comprises a plurality of slits arranged circumferentially around the exit orifice, the plurality of slits defining a plurality of resilient tabs configured to deflect radially outward when contacted by one or more formations on an outer surface of the rigid tube and configured to return to a neutral position when the one or more formations have passed through the exit orifice.

18. The wiper system of claim 17, wherein the plurality of resilient tabs comprises a resilient material selected from the group of materials consisting of polyurethane, neoprene, and spring metal.

19. The wiper system of claim 9, further comprising a conveyor for transporting the rigid tube through the tapered wiper.

20. The wiper system of claim 9, further comprising a coating delivery mechanism for delivering the one or more coatings.

21. A wiper system, comprising:
a dual-axis gimbal; and
a tapered wiper movably supported on the dual-axis gimbal, the tapered wiper tapering between a wider end defining an inlet orifice and a narrower end defining an exit orifice.

22. The wiper system of claim 21, wherein the dual-axis gimbal is configured to permit the tapered wiper to rotate freely about a first axis perpendicular to a longitudinal axis of the tapered wiper and to rotate freely about a second axis perpendicular to the longitudinal axis and orthogonal to the first axis when the tapered wiper is contacted by a rigid tube.
